(19) United States
(12) Patent Application Publication
(10) Pub. No.: US 2010/0161777 A1
(43) Pub. Date: Jun. 24, 2010

(54) Method and System For Providing A Subscription To A Tuple Based On A Variable Identifier

(76) Inventor: Robert P. Morris, Raleigh, NC (US)

Correspondence Address: SCENERA RESEARCH, LLC, 111 Corning Road, Suite 220, Cary, NC, 27518, US

(21) Appl. No.: 12/340,991

(22) Filed: Dec. 22, 2008

(51) Int. Cl. G06F 15/177

(52) U.S. Cl. 709/222

(57) ABSTRACT

Methods, systems and computer program products are described for providing a subscription to a tuple. In one aspect, a system comprises system components including a subscription profiler component configured to receive subscription information identifying a subscriber and identifying a tuple identifier expression including a variable identifying a stored data entity, and a tuple identifier evaluator component configured to determine a first tuple identifier by evaluating the tuple identifer expression with the variable set to a first current value stored in the data entity. The system also includes a subscription handler component configured to establish a subscription for the identified subscriber to a first tuple identified by the determined first tuple identifier, and a notification handler component configured to send a first notification message including tuple information from the first tuple to the identified subscriber.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

One mode of exchanging information over the Internet uses a publish/subscribe (pub/sub), asynchronous, communication protocol. The commands of an asynchronous protocol, such as a pub/sub communication protocol, are structured such that there need not be a one-to-one correspondence between messages exchanged between communication entities. In some cases a publisher of information via the protocol need not wait for, nor expect, a response from a receiver of a message. Moreover, a receiver need not send a request for each message received. That is, a receiver may receive multiple messages associated with a sent message and/or may receive an unsolicited message. Thus, unlike a request/response, synchronous protocol where the response is sent directly (synchronously) and only in response to the entity's request, the information can instead be sent to a receiver in the absence of a corresponding request from the receiver (i.e., asynchronous to any request for information).

According to pub/sub communication protocols, a pub/sub service can receive published information from a publisher and asynchronously deliver such information to receivers. Typically, the pub/sub service stores and organizes such information in a data entity known as a tuple, which in its broadest sense, is a data object containing one or more tuple elements into which information is organized and stored. The information stored in a tuple is associated with a principal, which can represent a user, a group, an application, an entity, or a device, that owns the tuple. Each tuple can be identified by a tuple identifier (ID), e.g., a uniform resource identifier (URI) or uniform resource locator (URL), and the principal can publish information to its associated tuple using the tuple ID.

An entity interested in receiving information published by a principal can subscribe to the principal's associated tuple by providing the tuple ID. When the principal publishes updated information identifying the tuple to be created or updated, the pub/sub service updates the tuple information and transmits the updated information to all interested entities, i.e., subscribers, via notification messages. The published information can be read simultaneously by any number of subscribers. So long as the subscriber remains subscribed to the tuple, the subscriber can continue to receive notification messages corresponding to the tuple principal's postings. Some pub/sub services can support filters that restrict the set of subscribers to whom updated information is transmitted.

Notably, as is used herein, the term “publish/subscribe” refers to the class of services and associated protocols where a subscribing client knows the tuple identifier, and thus the principal, of the tuple for which a subscription is to be established. Similarly, the publishing client knows the tuple identifier of the tuple to which it is publishing information, and can specify to which watching principals the tuple information should be sent, e.g., in a directed Publish or Notify. The subscriber receives only the most recently published information in a notification message resulting from a subscription. That is, the pub/sub service transmits to the subscriber only the most current state of the published information in response to new and/or updated tuple information.

In contrast to other services, the pub/sub services as described herein are not topic or content based subscription services. In topic based subscription services, sometimes also referred to as pub/sub services, publishers do not publish to identified tuples, nor do subscribers subscribe to tuples of identified principals. Publishers and subscribers can be anonymous. Depending on the variant of this type of service, publishers publish information to nowhere in particular allowing the service to examine the content of the information, and distribute it to subscribers based on content filters included in their subscriptions to an identified topic, an identified class, and/or an identified type. While sometimes referred to as pub/sub services, such topic and content based subscription services do not fall within the scope of the pub/sub services described herein.

As mentioned above, existing pub/sub services allow an entity interested in receiving information published by a principal to subscribe to the principal's associated tuple. Typically, the interested entity can subscribe to the tuple by providing the tuple ID to the pub/sub service. When the tuple ID is not known, however, subscribing to the tuple can be difficult if not impossible. Moreover, in some cases, an entity can be interested in receiving information in a tuple based on factors not relating to the tuple's principal and/or to the tuple's content. For example, an entity can be interested in receiving the last new record in a database. In these cases, existing pub/sub services are not capable of establishing a subscription to a tuple based on a factor other than a fixed tuple ID.

### SUMMARY

Methods, systems and computer program products are described for providing a subscription to a tuple. The methods, systems, and computer program products allow a principal to be subscribed to a tuple based on a result of an evaluation of an expression including a variable that identifies a stored data entity. At any given time, a value stored in the data entity can vary and therefore the evaluation of the expression can yield different results. Accordingly, the principal can be subscribed to different tuples depending on the different results without having prior knowledge of the tuple IDs. In one aspect, a system for providing a subscription to a tuple comprises system components including a subscription profiler component configured to receive subscription information identifying a subscriber and identifying a tuple identifier expression including a variable identifying a stored data entity, and a tuple identifier evaluator component configured to determine a first tuple identifier by evaluating the tuple identifer expression with the variable set to a first current value stored in the data entity. The system also includes a subscription handler component configured to establish a subscription for the identified subscriber to a first tuple identified by the determined first tuple identifier, and a notification handler component configured to send a first notification message including tuple information from the first tuple to the identified subscriber.

In another aspect of the subject matter disclosed herein, a system for providing a subscription to a tuple comprises system components including a subscription profiler component configured to receive subscription information identifying a subscriber and identifying a tuple identifier expression including a variable identifying a stored data entity, a service agent component configured to generate a message identifying the tuple identifier expression and the subscriber, and a protocol service agent component configured to send the message to a publish/subscribe service node configured to host a service for establishing a subscription for the identified subscriber to receive a notification including a current value of a tuple identified based on an evaluation of the tuple identifier expression.

In another aspect of the subject matter disclosed herein, a method and a computer readable medium storing a computer program, executable by a machine, for providing a subscription to a tuple includes executable instructions for receiving subscription information identifying a subscriber and identifying a tuple identifier expression including a variable identifying a stored data entity, determining a first tuple identifier by evaluating the tuple identifer expression with the variable set to a first current value stored in the data entity, establishing a subscription for the identified subscriber to a first tuple identified by the determined first tuple identifier, and sending a first notification message including tuple information from the first tuple to the identified subscriber.

In another aspect of the subject matter disclosed herein, another method and a computer readable medium storing a computer program, executable by a machine, for providing a subscription to a tuple includes executable instructions for receiving subscription information identifying a subscriber and identifying a tuple identifier expression including a variable identifying a stored data entity, generating by a service agent representing a principal a message identifying the tuple identifier expression and the subscriber, and sending by a protocol service agent the message to a publish/subscribe service node configured to host a service for for establishing a subscription for the identified subscriber to receive a notification including a current value of a tuple identified based on an evaluation of the tuple identifier expression.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a flow diagram illustrating a method for providing a subscription to a tuple according to an exemplary embodiment;

FIG. 2 is a block diagram illustrating a system for providing a subscription to a tuple according to an exemplary embodiment;

FIG. 3 is a block diagram illustrating another system for providing a subscription to a tuple according to another exemplary embodiment;

FIG. 4 illustrates a network in which a system for providing a subscription to a tuple can be implemented;

FIG. 5 a flow diagram illustrating another method for providing a subscription to a tuple according to another exemplary embodiment;

FIG. 6 is a block diagram illustrating a system for implementing the method of FIG. 5 according to an exemplary embodiment; and

FIG. 7 is a block diagram illustrating another system for implementing the method of FIG. 5 according to another exemplary embodiment.

### DETAILED DESCRIPTION

The subject matter presented herein allows a subscriber to subscribe to a tuple based on an evaluation of a tuple identifier in the form of an expression including a variable identifying a stored data entity configured to store a value. Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described. Various embodiments are described herein. The subject matter may be implemented using one of the embodiments described, any combination of the embodiments described including all of the embodiments, one of the embodiments described herein with other forms not described or any combination of the embodiments described including all of the embodiments with other forms not described.

According to an embodiment, a pub/sub communication architecture and its underlying messaging protocol allow published information to be sent to a subscriber as it is received, in many instances, substantially in real-time in relation to the publication of the information. Information is published within the pub/sub communication architecture using a publish command. The published information can then be communicated to a subscriber using a notify command. The notify command can either include the published information or can provide a reference to the published information.

By way of example, aspects of an embodiment described here can employ a presence protocol as the pub/sub communications protocol. It should be understood, however, the relevant techniques described here can be performed using any pub/sub communications protocol as defined herein. Additionally, the exemplary embodiment described herein is not limited to the use of a pub/sub protocol for all communications described. Other known protocols can also be used.

The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al, titled “Extensible Messaging and Presence Protocol (XMPP): Instant Messaging and Presence,” each of which are published and owned by the Internet Society and are hereby incorporated by reference in their entirety. A pub/sub protocol, as defined herein, includes any protocol meeting the requirements for a presence protocol as specified in RFC 2779 with the exception that there are no requirements for the content of a pub/sub tuple. That is, a pub/sub tuple is not required to support any particular content, such as status and contact means, as required by RFC 2779 for a presence protocol. Publish and notify messages identify the updated tuple and thus identify the publishing principal. Subscribe messages identify the subscriber.

Generally speaking, one or more service nodes are used to provide pub/sub services. The function of a service node, however, can be incorporated, either in whole or in part, into other entities. For example, the presence service model can be used. The presence service model described in RFC 2778 describes two distinct agents of a presence service client. The first of these agents, called a “presentity” (combining the terms “presence” and “entity”), provides presence information to be stored and distributed throughout the presence service on behalf of a presence client. The second type of presence agent is referred to as a “watcher.” Watchers receive presence information from a presence service on behalf of a presence client.

Users of the presence service are referred to, in the presence model described in RFC 2778, as principals. Typically, a principal is a person or group that exists outside of the presence model. A principal can also be a software component, a hardware component, or other resource capable of being represented by the presence service. A principal can interact with or otherwise be represented by the presence system through a “presence user agent” (PUA) or a “watcher user agent” (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

As mentioned above, a pub/sub service typically stores and organizes published information into tuples. A tuple can represent any element used to store the published information associated with a resource, e.g., a publisher/principal. The published information may include general contact information for the network resource, such as a name, a telephone number, an email address, a postal address, and IP addresses or uniform resource locators (URLs) associated with the resource, and the like, as well as other data or content. As used here, the tuple can also be a representation that maps field names to certain values to indicate that an entity or object (e.g., the principal) includes certain components, information, and/or perhaps has certain properties.

According to aspects of an embodiment described herein, a pub/sub service is configured to provide a subscription for a subscriber to a tuple based on an evaluation of a tuple identifier expression which includes a variable that identifies a stored data entity. In one embodiment, the pub/sub service is configured to receive subscription information identifying a subscriber and identifying the tuple identifier expression. The subscription information can be received from a client node over a network. In one embodiment, the identified subscriber can be a principal associated with the client node sending the subscription information, or, in another embodiment, can be a principal associated with another client node.

When the subscription information is received, the pub/sub service is configured to determine, in one embodiment, a tuple identifier by evaluating the tuple identifier expression with the variable set to a current value stored in the data entity identified by the variable included in the tuple identifier expression. Thereafter, the pub/sub service is further configured to establish a subscription for the identified subscriber to a tuple identified by the determined tuple identifier, and to send a notification message including tuple information from the tuple to the identified subscriber. In this manner, the pub/sub service can provide a subscription for a subscriber to a tuple based on a tuple identifier expression that includes a variable, the value of which can change according to a value stored in a data entity identified by the variable.

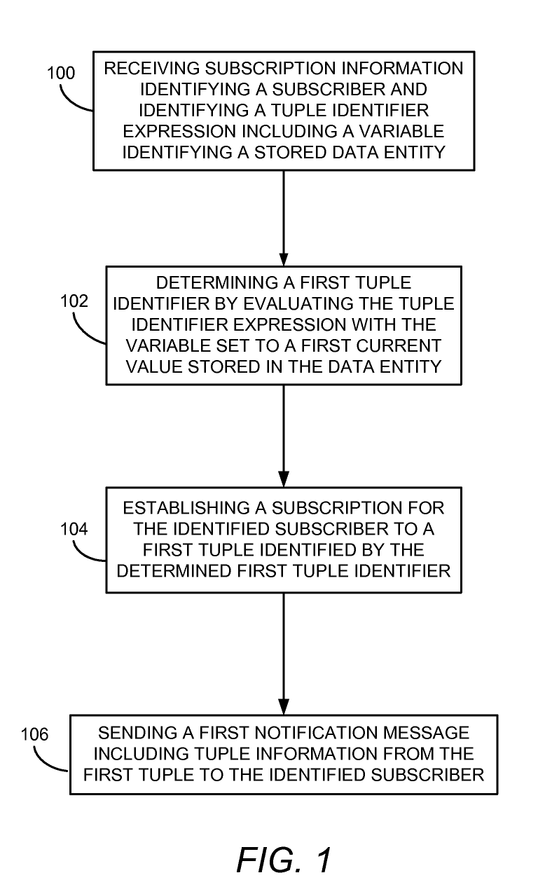

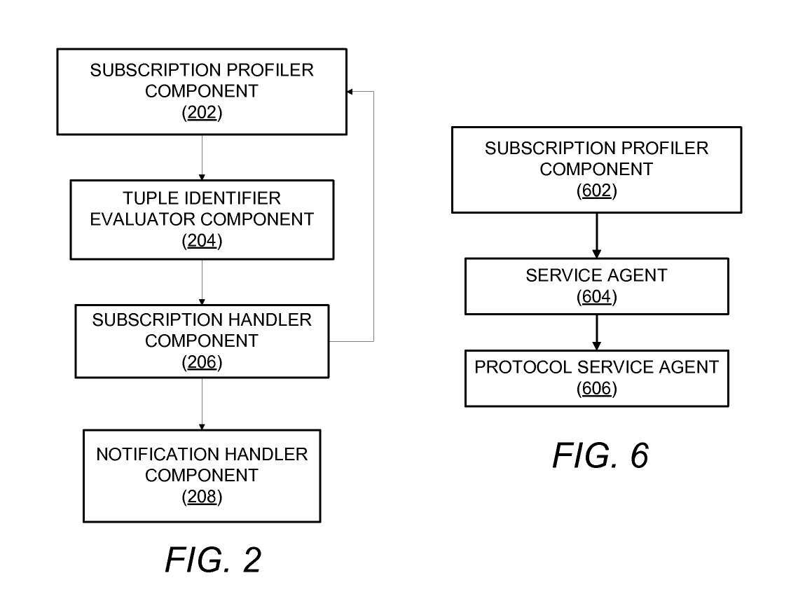

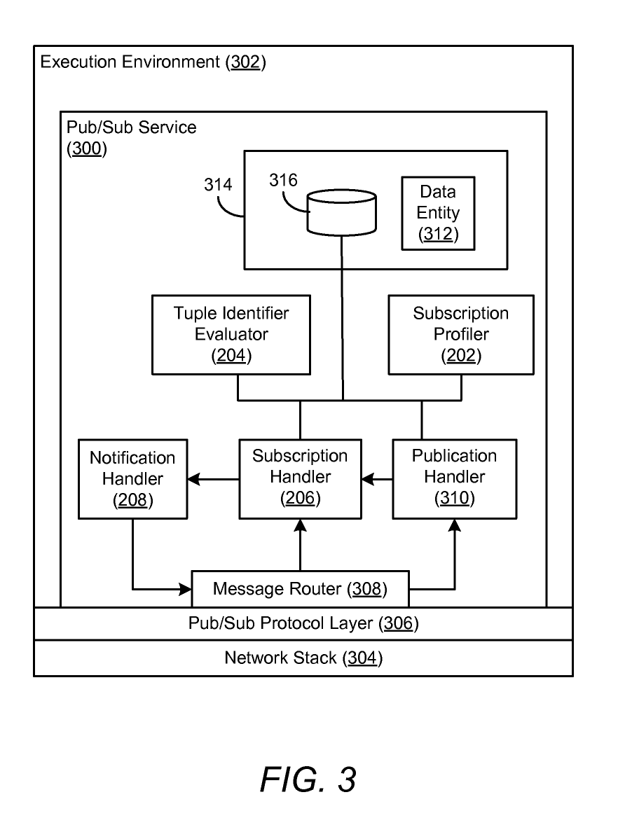

FIG. 1 is a flow diagram illustrating a method for providing a subscription to a tuple according to an exemplary embodiment. FIGS. 2 and 3 are block diagrams illustrating systems for providing a subscription to a tuple according to embodiments of the subject matter described herein. In particular, FIG. 2 illustrates an arrangement of components configured to provide a subscription to a tuple, while FIG. 3 illustrates the components of FIG. 2 and/or their analogs adapted for operation in an execution environment provided by a node for providing a subscription to a tuple. The method illustrated in FIG. 1 can be carried out by, for example, by at least some of the components in each of the exemplary arrangements of components illustrated in FIGS. 2 and 3.

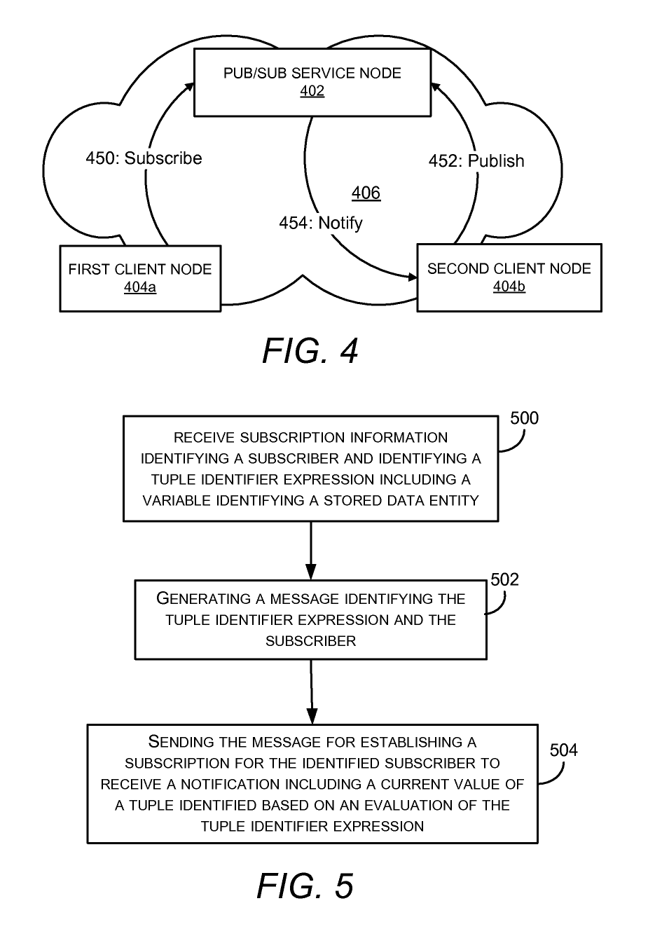

FIG. 2 illustrates an arrangement of components that are configured to operate within an execution environment hosted by a node and/or multiple nodes, as in a distributed execution environment. For example, in FIG. 4, which illustrates a plurality of nodes communicatively coupled to one another via a network 406 such as the Internet, a pub/sub service node 402 can be configured to provide an execution environment configured to support the operation of the components illustrated in FIG. 2 and/or their analogs. Exemplary nodes can include desktop computers, servers, networking nodes, notebook computers, PDAs, mobile phones, and digital image capture devices.

An execution environment can include a memory for storing components and an instruction processing component, such as processor and/or a digital signal processor (DSP), for processing instructions and any data associated with the operation of the components illustrated in FIG. 2. The components illustrated in FIG. 2, and functionally analogous components, each can require or otherwise make use of additional hardware and/or software subsystems according to their particular operational configurations. For example, a network subsystem can be included in the execution environment for enabling communication between nodes over the network 406. An operating system, a persistent data storage subsystem, a memory management subsystem, and/or a process scheduler are other examples of components that can be required for various adaptations of the components illustrated in FIG. 2 and their functional analogs for performing the method in FIG. 1.

Illustrated in FIG. 3 is a pub/sub service 300 including the components illustrated in FIG. 2 adapted for operating in an execution environment 302. The execution environment 302, or an analog, can be provided by a node such as the pub/sub service node 402. The pub/sub service 300 can include an accessible memory component 314 that includes a data entity 312 and a data store 316 for storing tuples and other data objects. In one embodiment, the tuples can be presence tuples that include a status element corresponding to a principal's status, and the pub/sub service 300 can be a presence service. The pub/sub service 300 can be configured to receive and send information from and to client nodes 404a, 404b via the network 406 using a pub/sub communications protocol, such as a presence protocol. The network 406 may be a Local Area Network (LAN) and/or a Wide Area Network (WAN) including the Internet.

With reference to FIG. 1, in block 100 subscription information identifying a subscriber and identifying a tuple identifier expression including a variable identifying a stored data entity is received. According to an embodiment, a system for providing a subscription to a tuple includes means for receiving subscription information identifying a subscriber and identifying a tuple identifier expression including a variable identifying a stored data entity. For example, FIG. 2 illustrates a subscription profiler component 202 configured to receive subscription information identifying a subscriber and identifying a tuple identifier expression including a variable identifying a stored data entity.

In one embodiment, the subscription profiler component 202 can be adapted for operation in the execution environment 302 where the subscription profiler component 202 can be included in a pub/sub service 300, such as, for example, a presence service. The subscription information can be received in a message from a node, such as a first client node 404A, via the network 406. The network 406 can support any protocol compatible with a configuration of the pub/sub service 300 and/or other components hosted by a node including a pub/sub service 300. For example, a suitable protocol can provide for sending the subscription information in a request in a request/response communication, in any messaging pattern supported by a pub/sub protocol, and/or in an asynchronous, unsolicited message.

According to an embodiment, the message can be transmitted over the network 406 and received by a network stack 304 in the execution environment 302. In one embodiment, at least a portion of the message can be formatted according to a pub/sub protocol, such as a presence protocol. The network stack 304 can be configured to provide at least the pub/sub formatted portion of the message to a pub/sub protocol layer 306, which in turn can pass the message to a message router component 308.

The message router component 308 can be configured to route the received message based on, for example, a message type detected in, and/or a schema supported by, the received information. For example, when the subscription information is included in a SUBSCRIBE message 450, such as that sent by the first client node 404a, the message router 308 can be configured to route the message to a subscription handler component 206 for processing. In one embodiment, the subscription handler component 206 can be configured to detect the tuple identifier (ID) expression identified by the received subscription information. In response to detecting the tuple ID expression, the subscription handler component 206 can provide at least the tuple ID expression in the subscription information to the subscription profiler component 202. Alternatively or additionally, the subscription handler component 206 can provide the subscription information to the subscription profiler component 202, and the subscription profiler component 202 can determine whether the subscription information identifies a tuple ID expression.

Alternatively, the subscription information can be received with tuple information for updating a tuple. For example, the subscription information can be received in a PUBLISH message 452 from a second client node 404b. The PUBLISH message 452 can also include the tuple information for updating a tuple. Alternatively, the subscription information can be received in a separate message along with the PUBLISH message 452 where the separate message can be associated with the PUBLISH message 452 via a message correlator. Under these circumstances, the message router 308 can be configured to route the message(s) to a publication handler component 310.

In one embodiment, in addition to being configured to update a tuple of the identified publisher, the publication handler component 310 can be configured to detect the subscription information identifying the tuple ID expression and identifying the subscriber in the published information. In response to detecting the tuple ID expression, the publication handler component 310 can provide the subscription information to the subscription handler component 206, which then can be configured to provide the subscription information to the subscription profiler component 202. Alternatively, the publication handler component 310 can provide the detected subscription information identifying the subscriber and identifying the tuple ID expression directly to the subscription profiler component 202.

In another embodiment, the subscription handler component 206 can be configured to detect an update to the tuple of the principal of the published information. In response to detecting the updated tuple, the subscription handler 206 can be configured to detect or otherwise identify subscription information from the updated tuple information in the tuple. In response to detecting the subscription information, the subscription handler 206 can provide the subscription information to the subscription profiler component 202.

Alternatively or additionally, the subscription information can be received in a message not compatible with a pub/sub protocol. For example, the message can be formatted specifically for exchanging the subscription information and can be received via a TCP (Transmission Control Protocol) or UDP (User Datagram Protocol) protocol layer supported by a network stack 304. The subscription information can be received in other protocols including HTTP (HyperText Transfer Protocol) and derivatives of HTTP such as SOAP (Simple Object Access Protocol), a management protocol such as SNMP (Simple Network Management Protocol), a LAN (local area network) protocol such as NetBIOS (Network Basic Input/Output System), and/or a link layer protocol such as IEEE 802.3 or 802.11. In another embodiment, the subscription information can be received from a user via a user interface. Still further, the subscription information can be received from a data storage device, for example, as configuration data for a pub/sub service 300.

As stated above, the subscription information received by the subscription profiler component 202 identifies a subscriber and a tuple ID expression including a variable identifying a stored data entity. In one embodiment, the identified subscriber can be a principal associated with the sending client node from which the subscription information is received, or can be a principal not associated with the sending client node. For example, when the subscription information is received in the PUBLISH message 452, the identified subscriber can be the publisher identified in the PUBLISH message 452, or can be another principal identified in the publish message 452, each represented by a watcher in a pub/sub client. The principal of the other client can operate in another node such as the first client node 404a.

According to one embodiment, the stored data entity identified by the variable in the tuple ID expression can be configured to store a simple value, such as an integer or a character, and/or a complex data item, such as a record or object. Alternatively or additionally, the data entity can provide storage for an attribute of a tuple and/or a principal associated with the tuple not stored in the principal's tuple. The data entity can store any value suitable for establishing a subscription for a system and/or a process implementing the method in FIG. 1.

According to one embodiment, the stored data entity, such as the data entity 312 shown in FIG. 3, can be in one contiguous memory region and/or can occupy two or more noncontiguous regions in an accessible memory component 314 of a receiving pub/sub service 300 operating in a service node 402. The data entity 312 can be stored in any region of memory accessible to the pub/sub service 300 including the tuple data store 316. For example, the data entity 312 can be an element of a tuple and/or an element included in, or includable in, a plurality of tuples.

Alternatively or additionally, the stored data entity 312 can be stored in a region of memory, such as RAM, in a hard drive accessible to the receiving pub/sub service 300, and/or in another node altogether whereby a value stored in the data entity 312 can be accessed by the pub/sub service 300 via a message. For example, the pub/sub service 300 can send a request for a value stored in the remote data entity (not shown) via the network 406, and receive the value in a response message. Alternatively, the pub/sub service 300 can receive the value via a notification message associated with a subscription to the remotely stored data entity. In yet another alternative, the value in the remotely stored data entity can be accessed by the pub/sub service 300 via an unsolicited, asynchronous message.

Once the subscription profiler component 202 receives the subscription information, the subscription profiler component 202 can be configured to process the subscription information and/or can store at least the tuple ID expression and subscriber identifier for processing in response to a subsequent event, such as a tuple update and/or a request to evaluate the tuple ID expression from a component included in the execution environment 302.

Returning to FIG. 1, once the subscription information is received, in block 102 a first tuple identifier is determined by evaluating the tuple ID expression with the variable set to a first current value stored in the data entity. According to an embodiment, a system for providing a subscription to a tuple includes means for determining a first tuple identifier by evaluating the tuple ID expression with the variable set to a first current value stored in the data entity. For example, FIG. 2 includes a tuple identifier (ID) evaluator component 204 configured for determining a first tuple identifier by evaluating the tuple ID expression with the variable set to a first current value stored in the data entity.

According to one embodiment, when the subscription information is received, the subscription profiler component 202 can invoke the tuple ID evaluator component 204 to evaluate the tuple ID expression by setting the variable in the expression to a first current value stored in the data entity 312. In another embodiment, the tuple ID evaluator 204 can be invoked in response to an update of a specified tuple, a specified group of tuples, or any portion of any tuple. Alternatively or additionally, the tuple ID evaluator 204 can be invoked in response to a change in a value stored in the data entity 312. In a still further alternative, the tuple ID evaluator 204 can be invoked at regular time intervals based on the setting of a timer. For example, the tuple ID evaluator 204 can be configured to make the determination every 60 minutes. In other cases, the determination can be made in response to detecting a change in metadata associated with a tuple or a principal. For example, such a change can include a change in an attribute associated with a tuple and/or its principal, but not included in the tuple, such as statistics and/or other metadata associated with the principal maintained and/or determined by the pub/sub service 300. In fact, the tuple ID evaluator 204 can be invoked in response to any suitable event or detected change including receiving a message from a component operating in the execution environment 302 and/or operating in another node and received via the network 406 in a message.

For example, in the pub/sub service 300, an update to a tuple can update an existing element of a tuple, create a new tuple, add a new subtuple and/or delete a subtuple to and/or from an existing tuple, and/or delete an entire tuple of a principal. In one embodiment, the update can be detected by the publication handler component 310, the subscription handler component 206, a data manager (not shown) and/or a notification handler component 208. For instance, a tuple update can be detected by the publication handler 310 in response to receiving a PUBLISH message including tuple information for updating the tuple, by the data manager of the data store 316 when it receives tuple information from the publication handler 310 along with an identifier of the tuple, by the subscription handler 310 when it is notified that the tuple has been updated by the publication handler 310 and/or by the data manager, and by the notification handler 208 when the notification handler 208 is invoked to send a notification including updated tuple information. According to one embodiment, the tuple ID evaluator component 204 can be invoked by the subscription profiler component 202, the publication handler 310, the subscription handler 206, and/or any component configured to detect the tuple update when an update is detected.

Once invoked, the tuple ID evaluator component 204 is configured to determine a tuple identifier of a tuple by evaluating the tuple ID expression with the variable set to a current value in the stored data entity 312. For example, the identified tuple ID expression can be the expression, “%lastUpdated%”. The tuple ID evaluator component 204 can be configured to detect a variable based on the pattern “%variablename%. The variable name, “lastUpdated,” can be detected and configured as a keyword identifying a stored data entity 312 representing a time tuple associated with a tuple having a value closest to a current time. In this example, the variable name “lastupdated” is a fixed name that refers to a data entity 312 whose value varies depending on the latest tuple update. Thus, depending on the current value stored in the data entity 312, the determined tuple identifier can change.

In another embodiment, a tuple ID expression can also include a selection criterion to further restrict tuple identification. The tuple ID evaluator component 204 can be configured to determine the tuple identifier based on the selection criterion and the variable set to the current value stored in the data entity. For example, the tuple ID expression can be “%lastUpdated% && (http://herbert.com/schemas/specialtuple==%tuple.schemaID%),” where the variable name is “lastUpdated,” and the selection criterion is “http://herbert.com/schemas/specialtuple==%tuple.schemaID%.” The result of an evaluation of this tuple ID expression would identify a tuple only when the tuple identified by the value stored in the “lastUpdated” variable is valid according to a schema identified in the selection criterion.

Alternatively, in another example, the selection criterion can be a threshold condition. When the tuple ID evaluator component 204 evaluates the tuple ID expression including the threshold condition, a tuple identifier can be determined when the threshold condition is met. The tuple ID evaluator component 204 can be configured to determine the tuple identifier of a tuple having data in a stored data entity that when evaluated in the expression in place of the variable satisfies the threshold condition. Alternatively, the tuple ID evaluator component 204 can be configured by information in the tuple ID expression or other information in a message including the tuple ID expression.

In one embodiment, the selection criterion can be based on several features, such as for example, a security interest, a performance indicator, and an attribute of a principal, and/or an attribute of a tuple. For example, the selection criterion can be based on a security interest when the identified subscriber belongs to a group, such as a company, having a security policy requiring a principal associated with an identified tuple to satisfy certain security conditions. In another example, the selection criterion can be based on an attribute of a principal of the tuple identified by the determined tuple identifier. In this case, the principal can have an attribute indicating the principal belongs to the same group as the identified subscriber and/or certifying the principal as an authorized service provider, for example.

Alternatively, a tuple ID expression can include two or more variables identifying two or more stored data entities maintained by the pub/sub service 300. For example, a variable named “herbertSpecial” can be defined to identify a stored data entity 312 whose value identifies a schema. Thus, the tuple ID expression “%lastUpdated% && %herbertSpecial%” identifies a tuple valid according to a schema identified by the value stored in the data entity named “herbertSpecial” that was most recently updated.

In a tuple ID expression, the sender of subscription information cannot specify the value of the identified variable, while in the selection criterion, a condition can be specified that must be satisfied in order to determine a tuple identifier. The selection criterion does not have to identify a tuple, while the tuple ID expression always identifies a tuple so long as the identified variable exists and has a valid value.

The determined tuple identifier can be an identifier of a tuple of a principal represented by a pub/sub client. Alternatively, the tuple identifier can identify a sub-tuple of a tuple of a principal represented by a pub/sub client. The sub-tuple identifier alone can identify the sub-tuple as a tuple maintained by the pub/sub service 300. Alternatively, the tuple identifier identifying the principal represented by a pub/sub client can be combined with an identifier of a sub-tuple and/or associated tuple owned by the principal. Thus, the determined tuple identifier can be a single value or a combination of values. In the latter case, the tuple identifier can be referred to as a combination tuple identifier.

A tuple identifier that includes a combination of values can be determined by evaluating a tuple ID expression providing a combination result, such as a tuple of values. For example, in one embodiment, the tuple ID expression can include multiple sub-expressions, which are evaluated separately to produce multiple values in a combination tuple identifier. At least a portion of a tuple identifier can be included in a tuple identified by the tuple identifier, can be in a tuple including the tuple identified by the tuple identifier, and/or can be in a tuple related to the identified tuple.

To illustrate further the subject matter described above, please consider the following example where a pub/sub service 300, such as a presence service, is configured to support tuples for request-response communications. A request tuple can be supported along with an associated operation ID tuple for including a value(s) identifying a type of operation requested. An operation can be a principal represented by a tuple including a request tuple and a response tuple. Alternatively, each of a request and a corresponding response can be principals each having a tuple. In yet another alternative, a request tuple and/or a response tuple can be included in a tuple of an owning or controlling principal. Each of the exemplary tuples can have a simple or a combination tuple identifier.

In this example, subscription information identifying a subscriber and identifying a tuple ID expression can be received by the pub/sub service 300 in a subscribe message 450 sent from the first client node 404a by a pub/sub client representing a principal providing a sorting operation that sorts a provided list of names alphabetically. The subscription information can identify the principal represented by the pub/sub client in the first client node 404a and/or can identify another principal represented by at least a watcher component of a pub/sub client configured to receive notifications including update information including data included in an identified updated tuple.

The tuple ID expression identified in the subscription information can be or can have semantics analogous to any one of the following three exemplary expressions:

| | |
|---|---|
| (1) | %sortNameList% |
| (2) | %sortNameList% && (%param.type% is “text/xml”) |
| (3) | “%sortNameList% and %param.type.text/xml% and |
| | %performance.response.average%” |

Each successive expression is more restrictive than its preceding expression. For example, expression (2) includes a selection criterion that requires a “param” type to be “text/xml.” In expression (3), three variables are specified that identify the intersection, rather than the union, of the tuples identified by each of the three variables. Note that other semantics can be included in the tuple ID expression.

When the subscription information is received, the subscription profiler component 202 can be configured to process the subscription information and/or store at least the tuple ID expression and subscriber identifier identified by the subscription information for processing in response to a subsequent event, such as a tuple update.

In this example, a second client node 404b can host an application configured to send a request to sort a large list of names via a PUBLISH message 452 to the pub/sub service node 402 hosting the pub/sub service 300. The request can include an exemplary request tuple below:

```
<request>
  <operationID>sortNameList@littleinc.com</operationID>
  <status>pending</status>
  <param>
    <type>text/xml</type>
    <ref>http://littleco.com/data/accountMgmt/employees.xml</ref>
  </param>
</request>
```

In the request tuple above, the “operationID” tuple element can be specified as a tuple owner tuple element. The “@littleinc.com” portion of the operationID tuple element can be defined to identify an owner of the tuple. When the PUBLISH message 452 is received, a tuple identified in the message is updated. In response to this update, the tuple ID evaluator component 204 can be invoked to evaluate one of the exemplary tuple ID expressions above.

According to one embodiment, the tuple ID evaluator component 204 can be configured to detect variables as strings enclosed in ‘%’ characters. Thus, for a tuple ID evaluator component 204 properly configured to evaluate expression (1) above, the variable name “sortNameList” can be defined to identify a stored data entity 312 that includes a value, either simple or structured, identifying one or more tuples including a “sortNameList” operation identifier. The “sortNameList” variable can be a list of all the sortNamelist request tuples.

Alternatively, for a tuple ID evaluator component 204 properly configured to evaluate expression (2) above, the variable name “param.type.text/html” can be defined to identify a stored data entity 312 including a value identifying one or more tuples that include a <param> with a type sub-element identifying the content type of the <param> element is HTML. Alternatively, for a tuple ID evaluator component 204 properly configured to evaluate expression (3) above, the variable name “performance.response.average” can be defined to identify a stored data entity 312 for storing a value that identifies one or more tuples with “average” response, as defined by the configuration of the particular pub/sub service 300.

For example, the pub/sub service 300 can be configured to measure response times of various operation providers based on one or more times a notification is sent to a provider including request information, and one or more corresponding times a response from the provider is received. A response time metric can be stored defining an average response time. The value stored can be a single value, a range of values, or a series of discrete values. Each provider tuple can have a value of the metric included in the provider's tuple and/or stored in a separate tuple associated with the provider, for example, by including an identifier of the provider in the associated tuple.

Alternatively, the variable name “performance.response.average” can be defined to identify a response time threshold stored data entity 312 in the accessible memory for storing an average response time for an operation provider. The average can be set by configuration data received from a user via a user interface, determined by or dynamically based on a configured policy, and/or provided by a requesting principal in or otherwise associated with the published request information. Alternatively, the “performance.response.average” stored data entity 312 can store identifiers of one or more tuples of providers that have “average” response times. The exemplary variables described above are clearly not exhaustive.

According to one embodiment, the tuple ID evaluator component 204 can be configured to evaluate one or more of the exemplary tuple ID expressions according to a schema for tuple ID expressions defining a format, structure, and/or semantics of a valid expression to which any one of the evaluated examples conforms. In each case, the tuple identifier identifying the exemplary request tuple can be determined.

For example, the tuple ID evaluator component 204 can evaluate expression (1) to determine a tuple identifier identifying the exemplary request tuple based on the operation ID's user portion matching “sortNameList”. The tuple ID evaluator component 204 can be configured to determine a single request or up to a specified threshold of requests previously sent to the subscriber, or to determine a tuple based on any other additional criteria according to a configuration of the pub/sub service 300. For expression (2), the tuple ID evaluator component 204 can identify the exemplary request tuple based on the operation ID's user portion matching “sortNameList” and a tuple including a type tuple in a param tuple as identified by the “param.type” variable. Finally for expression (3), the tuple ID evaluator component 204 can further identify the exemplary request tuple based on the operation ID's user portion matching “sortNameList”, a tuple including a type tuple in a param tuple as identified by the “param.type” variable, and a performance response time threshold identifying a stored data entity including a value providing a response time determined to be average.

According to one embodiment, the subscription information can further include one or more additional matching criterion to be evaluated along with the tuple ID expression for filtering and/or ranking identified tuples. For example, an additional matching criterion can include data for matching reliability information. Reliability information can be stored in an identifiable data entity. Alternatively, a variable in an additional matching criterion can be provided by the pub/sub service 300 and/or other component included in or interoperating with the pub/sub service 300. The reliability data can be a value provided by a publishing or subscribing principal in a message via any of various other configuration mechanisms. The matching criterion and/or the tuple ID expression including a reliability variable determines, when evaluated, whether the identified subscriber providing the operation meets a reliability requirement specified for the request.

Alternatively, a provider variable can be included in the matching criterion and/or tuple ID expression identifying reliability data for the operation provider maintained by, for example, the pub/sub service 300. Thus, the requester reliability variable and the provider reliability variable can be set to the values in the corresponding data entities by the tuple ID evaluator 204. The requester reliability variable stores a value, threshold, or range of reliability required by a requester. The provider reliability variable is a statement by or a measure of the reliability of the provider. The evaluation can determine a criterion for including or excluding a tuple when included in a matching criterion separate from a tuple ID expression. The evaluation can determine an identifier for determining whether the published tuple is an identified tuple matching the evaluated tuple ID expression.

In another embodiment, a PUBLISH message from a client node that includes a pub/sub client representing an application for publishing a request for a specified operation, e.g., a data sort operation, can also include subscription information identifying a tuple ID expression including a variable identifying one or all of the elements described above. The tuple ID evaluator component 204 can be invoked in response to receiving the subscription information, and can be configured to determine a tuple identifier of a tuple associated with a watching client. The watching client can have an associated attribute included in a stored data entity 312 that results in a matching indication received from evaluating the tuple ID expression, setting one or more variables in the expression to one or more values in the data entity 312.

For example, the second client node 404b can send a PUBLISH message 452 that includes the sort request and a tuple ID expression having a variable to be matched for an indicator of a sort function and performance variable. The message can also include additional information that when received by the tuple ID evaluator component 204 is first evaluated to determine one or more tuple identifiers of tuples associated with watching clients that have a data entity including a value that matches the operation type variable. From the one or more determined watching clients, the tuple ID evaluator component 204 can set a performance variable in the tuple ID expression to determine a performance level indicating response time based on a value in a stored data entity associated with each determined watching client. The tuple ID evaluator component 204 can also be configured to select the determined watching client having a best response time according to the additional information received. Alternatively, the tuple ID evaluator component 204 can be configured to determine the single best watching client providing a sort operation or can be configured to determine the top three watching clients based on the determined response time levels for each watching client providing a sort operation.

In one embodiment, the PUBLISH message 452 can include request information that is sent, for example, in a notification message, to one or more watching clients each having an associated attribute included in a stored data entity 312 that results in a matching indication received from evaluating the tuple ID expression. The tuple ID evaluator component 204 can be configured to receive responses to the request information in the PUBLISH message 452 from the watching clients, and to select a best watching client based on the responses and establish a subscription for the sender of the request identified in the PUBLISH message. The subscription is to a tuple of the best watching client including receive response information allowing the requester to receive a response in a NOTIFICATION message. Alternatively, the best watching client can be determined prior to receiving a response and the subscription can be established prior to receiving the response.

Referring again to FIG. 1, when the first tuple identifier is determined, in block 104 a subscription is established for the identified subscriber to a first tuple identified by the determined first tuple identifier. According to an embodiment, a system for providing a subscription to a tuple includes means for establishing a subscription for the identified subscriber to a first tuple identified by the determined first tuple identifier. For example, FIG. 2 includes a subscription handler component 206 configured to establish a subscription for the identified subscriber to a first tuple identified by the determined first tuple identifier.

According to an embodiment, the subscription handler component 206 can be invoked when the tuple ID evaluator component 204 determines the first tuple identifier. Once invoked, the subscription handler component 206 can be configured to receive the first tuple identifier from the tuple ID evaluator component 204, and to establish the subscription by adding an identifier associated with the identified subscriber to a subscription list associated with the first tuple.

For example, when the second client node 404b sends a PUBLISH message 452 that includes a sort request and a tuple ID expression having a variable to be matched for an indicator of a sort function and performance variable, and the tuple ID evaluator component 204 determines a tuple identifier of a tuple associated with a watching client that has a data entity including a value that matches the operation type variable, a subscription to the tuple of the watching client can be established for the identified subscriber, e.g., a principal identified in the PUBLISH command. In one embodiment, the PUBLISH message 452 can include request information that is sent to the determined watching client, and the watching client can publish its response to the watching client's tuple. Based on its subscription, the identified subscriber can receive the response published by the watching client, for example, in a NOTIFY message 454.

Referring again to FIG. 1, in block 106 a first notification message including tuple information from the first tuple is sent to the identified subscriber. According to an embodiment, a system for providing a subscription to a tuple includes means for sending a first notification message including tuple information from the first tuple to the identified subscriber. For example, FIG. 2 includes a notification handler component 208 configured to send a first notification message including tuple information from the first tuple to the identified subscriber.

According to an embodiment, the subscription handler component 206 can be configured to provide for generating a notification to be sent to a watcher representing a principal associated with the identified subscriber. For example, the subscription handler component 206 can be configured to interoperate with the notification handler component 208 for generating a notification including tuple information from the first tuple in a notification message. The notification message can be provided to the message router component 308 by the notification handler component 208 for sending to the identified subscriber. For example, the message router component 308 can be configured to interoperate with the pub/sub protocol layer 306 for sending the updated tuple information to the watcher representing the identified subscriber, e.g., associated with the second client node 404b, in a NOTIFY message 454 formatted according to the configured pub/sub protocol via the network protocol stack 304 and the network 406.

According to one embodiment, the tuple ID evaluator component 204 can be invoked when an update to the value stored in the data entity 312 is detected. When such an update is detected, e.g., by the publication handler component 310 or by the subscription handler component 206, the tuple ID evaluator component 204 can reevaluate the tuple identifier expression with the variable now set to the updated value stored in the data entity 312 and can determine a second tuple identifier. In response, the subscription handler component 206 can be invoked to establish a subscription for the identified subscriber to a second tuple identified by the determined second tuple identifier, and the notification handler component 208 can be directed to send a second notification message including tuple information from the second tuple to the identified subscriber. In one embodiment, the subscription to the first tuple can be maintained or terminated depending on the configuration of the pub/sub service 300 or the preferences of the identified subscriber.

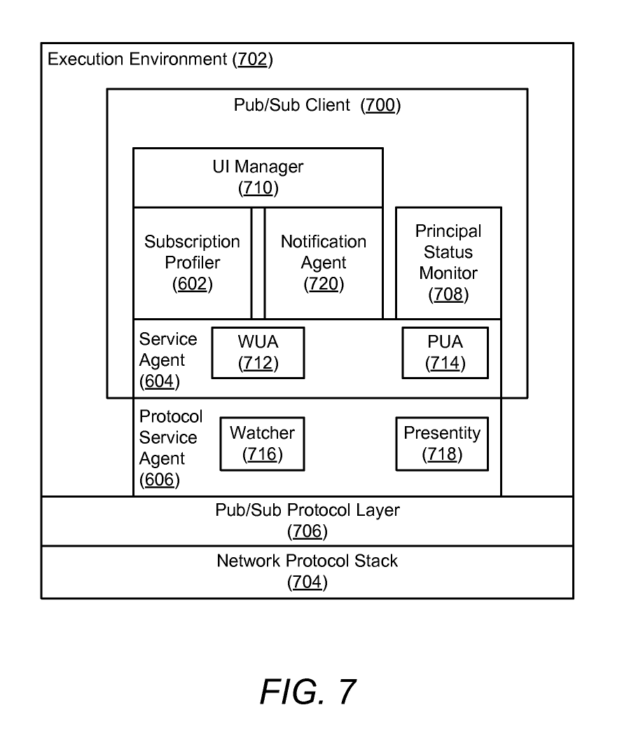

FIG. 5 is a flow diagram illustrating a method for providing a subscription to a tuple according to another aspect of the subject matter described herein. FIGS. 6 and 7 are block diagrams illustrating systems for providing a subscription to a tuple according to other embodiments. In particular, FIG. 6 illustrates components configured for providing a subscription to a tuple, while FIG. 7 illustrates the components of FIG. 6 and/or their analogs adapted for operation in an execution environment provided by a node for providing a subscription to a tuple. The method illustrated in FIG. 5 can be carried out by, for example, by at least some of the components in each of the exemplary arrangements of components illustrated in FIGS. 6 and 7.

The components illustrated in FIG. 6 are configured to operate within an execution environment hosted by a node and/or multiple nodes. For example, in FIG. 4, a client node, such as the first client node 404a, can be configured to provide an execution environment configured to support the operation of the components illustrated in FIG. 6 and/or their analogs.

Illustrated in FIG. 7 is a pub/sub client 700 including the components illustrated in FIG. 6 adapted for operating in an execution environment 702. As mentioned above, the execution environment 702, or an analog, can be provided by a node such as the first client node 404a. The pub/sub client 700 operating in the client node 404a can be configured to receive and send information from and to other client nodes 404b and the pub/sub service node 402 via the network 406 using a pub/sub communications protocol, such as a presence protocol.

With reference to FIG. 5, in block 500 subscription information identifying a subscriber and identifying a tuple ID expression including a variable identifying a stored data entity is received. According to an exemplary embodiment, a system for providing a subscription to a tuple includes means for receiving subscription information identifying a subscriber and identifying a tuple ID expression including a variable identifying a stored data entity. For example, FIG. 6 illustrates a subscription profiler component 602 configured to receive subscription information identifying a subscriber and identifying a tuple ID expression including a variable identifying a stored data entity.

In one embodiment, the subscription profiler component 602 can receive the subscription information via a user interface (UI) manager component 710 configured to receive the subscription information from or otherwise in response to a user via an input device of a hosting node, e.g., the first client node 404a. Alternatively or additionally, the subscription profiler component 602 can receive the subscription information from a message sent from a client node, e.g., the second client node 404b. In addition, the subscription information can be received from an application and/or from configuration data in a local data store (not shown).

As described above, the identified subscriber in the subscription information can be a principal associated with the first client node 404a receiving the subscription information, or can be a principal associated with another client node, such as the second client node 404b. The tuple ID expression includes a variable identifying a stored data entity, which can be configured to store a simple value, such as an integer or a character, and/or a complex data item, such as a record or object. Alternatively or additionally, the data entity can provide storage for an attribute of a tuple and/or a principal associated with the tuple not stored in the principal's tuple. According to an embodiment, when the tuple ID expression is evaluated, e.g., by the pub/sub service 300, with the variable set to a current value stored in the data entity, a tuple identifier can be determined. In one embodiment, the determined tuple identifier identifies a tuple to which the identified subscriber is provided a subscription.

According to an embodiment, the tuple ID expression can also include a selection criterion to further restrict tuple identification. The selection criterion can be based on several features, such as for example, a security interest, a performance indicator, and an attribute of a principal, and/or an attribute of a tuple, as described above.

Referring again to FIG. 5, once the subscription information is received, in block 502 a message identifying the tuple identifier expression and the subscriber is generated. According to an exemplary embodiment, a system for providing a subscription to a tuple includes means for generating a message identifying the tuple identifier expression and the subscriber. For example, FIG. 6 illustrates a service agent component 604 configured to generate a message identifying the tuple identifier expression and the subscriber.

According to an embodiment, the service agent component 604 can be configured to generate a message formatted according to a variety of schemas that identify the tuple ID expression and the identified subscriber. For example, in the pub/sub client 700, the service agent component 604 can include a WUA 712 and a PUA 714 configured to generate a SUBSCRIBE message and a PUBLISH message, respectively, that identifies the tuple ID expression and the subscriber. The SUBSCRIBE and/or PUBLISH message can be formatted according to a pub/sub protocol, such as a presence protocol.

In one embodiment, the PUBLISH message can be generated to be published to a tuple for receiving the subscription information. The tuple for receiving the subscription information can be the tuple of the principal represented by the PUA 714 or another tuple. The PUBLISH message can include tuple information for the publishing principal, such as a status and/or a location of the principal provided by a principal status monitor 708. The subscription information can be included in the same generated PUBLISH message as a single tuple or as multiple tuples. Alternatively, the message can be generated in correspondence with generating a message including tuple information for the publishing principal. In this case, the messages can be correlated by including a correlator in each, or by correspondence in time. In another embodiment, a SUBSCRIBE message can be generated by the WUA 712, and the subscription information can be included in the SUBSCRIBE message.

Referring again to FIG. 5, once the message is generated, in block 504 the message is sent to a pub/sub service node configured to host a service for establishing a subscription for the identified subscriber to receive a notification including a current value of a tuple identified based on an evaluation of the tuple ID expression. In one embodiment, the service is configured to determine a tuple identifier identifying the tuple for which a subscription is established by evaluating the tuple ID expression with the variable set to a current value stored in the data entity.

According to an exemplary embodiment, a system for providing a subscription to a tuple includes means for sending the message to the pub/sub service node 402. For example, FIG. 6 illustrates a protocol service agent component 606 configured to send the message to a pub/sub service node 402 configured to host a service for establishing a subscription for the identified subscriber to receive a notification including a current value of a tuple identified based on an evaluation of the tuple identifier expression.

The protocol service agent component 606, in one embodiment, can be configured to send the message generated by the service agent component 604 to the pub/sub service node 402 via the network 406 according to a suitable communication protocol, of which a large number exist or can be defined. For example, in the pub/sub client 700, the protocol service agent component 606 can include a watcher 716 and a presentity 718 each configured to support communication via a pub/sub protocol such as a presence protocol.

Either or both of the presentity 718 and the watcher 716 can send the message according to the configuration of the pub/sub client 700. The presentity 718 can send the generated message as a PUBLISH message and/or the watcher 716 can send the message as a SUBSCRIBE message. The message can be provided to the pub/sub protocol layer 706 by either of the watcher 716 or presentity 718 as determined by the configuration of the pub/sub client 700. The pub/sub protocol layer 706 can be configured to package the message for sending. Such packaging can include reformatting the message, breaking the message into packets, including at least a portion of the message along with at least a portion of another message to be transmitted together, and/or adding additional information such as a header or trailer as specified by the protocol used.

As stated above, the service hosted by the pub/sub service node 402 is configured to evaluate the tuple ID expression with the variable set to a current value stored in the data entity to determine a tuple identifier. The determined tuple identifier is then used to identify a tuple for which a subscription is established for the identified subscriber. The service can be configured to send a notification message including tuple information from the identified tuple to the identified subscriber.

According to one embodiment, the pub/sub client 700 operating in the client node 404a can include a notification agent component 720 configured to receive the notification message including the tuple information from the tuple identified by the tuple identifier determined by an evaluation of the tuple ID expression based on a current value of the stored data entity assigned to the variable. When the value of the stored data entity is updated to a new value, the notification agent component 720 can be configured to receive a new notification message that includes tuple information from another tuple identified by another tuple identifier determined by another evaluation of the expression based on the new value of the stored data entity assigned to the variable.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A system for providing a subscription to a tuple, the system comprising system components including:
a subscription profiler component configured to receive subscription information identifying a subscriber and identifying a tuple identifier expression including a variable identifying a stored data entity;
a tuple identifier evaluator component configured to determine a first tuple identifier by evaluating the tuple identifer expression with the variable set to a first current value stored in the data entity;
a subscription handler component configured to establish a subscription for the identified subscriber to a first tuple identified by the determined first tuple identifier; and
a notification handler component configured to send a first notification message including tuple information from the first tuple to the identified subscriber,
wherein at least one of the system components includes at least one electronic hardware component.

2. The system of claim 1 wherein the subscriber profiler component is configured to receive the subscription information from at least one of a message sent from a sending client node via a network, a user via a user interface, and configuration data in a local data store.

3. The system of claim 2 wherein the message including the subscription information is formatted according to a publish/subscribe protocol and is at least one of a subscribe message and a publish message.

4. The system of claim 3 wherein the publish/subscribe protocol is a presence protocol.

5. The system of claim 2 wherein the identified subscriber is one of a principal associated with the sending client node from which the subscription information is received, and a principal not associated with the sending client node.

6. The system of claim 1 wherein the tuple identifier evaluator is invoked in response to at least one of receiving the subscription information by the subscription profiler, updating at least one of a specified tuple, changing a value stored in the data entity, and detecting an event based on an attribute of time.

7. The system of claim 1 wherein the data entity is at least one of a contiguous memory region in an accessible memory component, two or more noncontiguous regions in the accessible memory, an element of a tuple, and an element included in a plurality of tuples, and wherein the data entity is configured to store at least one of a simple value, a complex data item, and an attribute of at least one of a tuple and a principal associated with the tuple.

8. The system of claim 1 wherein the tuple identifier expression further includes a selection criterion and the tuple identifier evaluator component is configured to determine the first tuple identifier based on the variable set to a first current value stored in the data entity and the selection criterion.

9. The system of claim 8 wherein the selection criterion is based on at least one of a security interest, a performance indicator, an attribute of a principal, and an attribute of a tuple.

10. The system of claim 1 wherein the tuple identifier evaluator is configured to determine a second tuple identifier by evaluating the tuple identifier expression with the variable set to a second current value stored in the data entity, the subscription handler component is configured to establish a subscription for the identified subscriber to a second tuple identified by the determined second tuple identifier, and the notification handler component is configured to send a second notification message including tuple information from the second tuple to the identified subscriber.

11. A system for providing a subscription to a tuple, the system comprising system components including:
a subscription profiler component configured to receive subscription information identifying a subscriber and identifying a tuple identifier expression including a variable identifying a stored data entity;
a service agent component configured to generate a message identifying the tuple identifier expression and the subscriber; and
a protocol service agent component configured to send the message to a publish/subscribe service node configured to host a service for establishing a subscription for the identified subscriber to receive a notification including a current value of a tuple identified based on an evaluation of the tuple identifier expression,
wherein at least one of the system components includes at least one electronic hardware component.

12. The system of claim 11 wherein the subscription profiler component is configured to receive the subscription information from at least one of a message sent from a client node, a message from an application, a user via a user interface, and configuration data in a local data store.

13. The system of claim 11 wherein the generated message including the subscription information is formatted according to a publish/subscribe protocol and is at least one of a subscribe message and a publish message.

14. The system of claim 11 wherein the tuple identifier expression further includes a selection criterion based on at least one of a security interest, a performance indicator, an attribute of a principal, and an attribute of a tuple.

15. The system of claim 11 wherein the message including the subscription information is correlated with another message including tuple information associated with a principal represented by the service agent.

16. The system of claim 11 wherein the identified subscriber is associated with a principal that is different from a principal represented by the service agent.

17. The system of claim 11 further comprising a notification agent component configured to receive a first notification message including first tuple information from a first tuple identified by a first tuple identifier determined by a first evaluation of the expression based on a first current value of the stored data entity assigned to the variable.

18. The system of claim 17 wherein the notification agent component is configured to receive a second notification message including second tuple information from a second tuple identified by a second tuple identifier determined by a second evaluation of the expression based on a second current value of the stored data entity assigned to the variable.

19. A system for providing a subscription to a tuple, the system comprising:
means for receiving subscription information identifying a subscriber and identifying a tuple identifier expression including a variable identifying a stored data entity;
means for determining a first tuple identifier by evaluating the tuple identifer expression with the variable set to a first current value stored in the data entity;
means for establishing a subscription for the identified subscriber to a first tuple identified by the determined first tuple identifier; and
means for sending a first notification message including tuple information from the first tuple to the identified subscriber,
wherein at least one of the means includes at least one electronic hardware component.

20. A system for providing a subscription to a tuple, the system comprising:
means for receiving subscription information identifying a subscriber and identifying a tuple identifier expression including a variable identifying a stored data entity;
means for generating a message identifying the tuple identifier expression and the subscriber; and
means for sending the message to a publish/subscribe service node configured to host a service for establishing a subscription for the identified subscriber to receive a notification including a current value of a tuple identified based on an evaluation of the tuple identifier expression,
wherein at least one of the means includes at least one electronic hardware component.

21. A method for providing a subscription to a tuple, the method comprising:
receiving subscription information identifying a subscriber and identifying a tuple identifier expression including a variable identifying a stored data entity;
determining a first tuple identifier by evaluating the tuple identifer expression with the variable set to a first current value stored in the data entity;
establishing a subscription for the identified subscriber to a first tuple identified by the determined first tuple identifier; and
sending a first notification message including tuple information from the first tuple to the identified subscriber,
wherein at least one of the preceding actions is performed on at least one electronic hardware component.

22. The method of claim 21 wherein the subscription information is received from at least one of a message sent from a sending client node via a network, a user via a user interface, and configuration data in a local data store.

23. The method of claim 22 wherein the message including the subscription information is formatted according to a publish/subscribe protocol and is at least one of a subscribe message and a publish message.

24. The method of claim 23 wherein the publish/subscribe protocol is a presence protocol.

25. The method of claim 22 wherein the identified subscriber is one of a principal associated with the sending client node from which the subscription information is received, and a principal not associated with the sending client node.

26. The method of claim 21 wherein determining the first tuple identifier is in response to at least one of receiving the subscription information, updating at least one of a specified tuple, changing a value stored in the data entity, and detecting an event based on an attribute of time.

27. The method of claim 21 wherein the data entity is at least one of a contiguous memory region in an accessible memory component, two or more noncontiguous regions in the accessible memory, an element of a tuple, and an element included in a plurality of tuples, and wherein the data entity is configured to store at least one of a simple value, a complex data item, and an attribute of at least one of a tuple and a principal associated with the tuple.

28. The method of claim 21 wherein the tuple identifier expression further includes a selection criterion, and wherein determining the first tuple identifier is based on the variable set to a first current value stored in the data entity and the selection criterion.

29. The method of claim 28 wherein the selection criterion is based on at least one of a security interest, a performance indicator, an attribute of a principal, and an attribute of a tuple.

30. The method of claim 21 further comprising:
determining a second tuple identifier by evaluating the tuple identifier expression with the variable set to a second current value stored in the data entity;
establishing a subscription for the identified subscriber to a second tuple identified by the determined second tuple identifier; and
sending a second notification message including tuple information from the second tuple to the identified subscriber.

31. A method for providing a subscription to a tuple, the method comprising:
receiving subscription information identifying a subscriber and identifying a tuple identifier expression including a variable identifying a stored data entity;
generating by a service agent representing a principal a message identifying the tuple identifier expression and the subscriber; and
sending by a protocol service agent the message to a publish/subscribe service node configured to host a service for establishing a subscription for the identified subscriber to receive a notification including a current value of a tuple identified based on an evaluation of the tuple identifier expression,
wherein at least one of the preceding actions is performed on at least one electronic hardware component.

32. The method of claim 31 wherein the subscription information is received from at least one of a message sent from a client node, a message from an application, a user via a user interface, and configuration data in a local data store.

33. The method of claim 31 wherein the generated message including the subscription information is formatted according to a publish/subscribe protocol and is at least one of a subscribe message and a publish message.

34. The method of claim 31 wherein the tuple identifier expression further includes a selection criterion based on at least one of a security interest, a performance indicator, an attribute of a principal, and an attribute of a tuple.

35. The method of claim 31 wherein the message including the subscription information is correlated with another message including tuple information associated with the principal represented by the service agent.

36. The method of claim 31 wherein the identified subscriber is associated with a principal that is different from the principal represented by the service agent.

37. The method of claim 31 further comprising receiving a first notification message including first tuple information from a first tuple identified by a first tuple identifier determined by a first evaluation of the expression based on a first current value of the stored data entity assigned to the variable.

38. The method of claim 37 further comprising receiving a second notification message including second tuple information from a second tuple identified by a second tuple identifier determined by a second evaluation of the expression based on a second current value of the stored data entity assigned to the variable.

39. A computer readable medium storing a computer program, executable by a machine, for providing a subscription to a tuple, the computer program comprising executable instructions for:
receiving subscription information identifying a subscriber and identifying a tuple identifier expression including a variable identifying a stored data entity;
determining a first tuple identifier by evaluating the tuple identifer expression with the variable set to a first current value stored in the data entity;
establishing a subscription for the identified subscriber to a first tuple identified by the determined first tuple identifier; and
sending a first notification message including tuple information from the first tuple to the identified subscriber.

40. A computer readable medium storing a computer program, executable by a machine, for providing a subscription to a tuple, the computer program comprising executable instructions for:
receiving subscription information identifying a subscriber and identifying a tuple identifier expression including a variable identifying a stored data entity;
generating by a service agent representing a principal a message identifying the tuple identifier expression and the subscriber; and
sending by a protocol service agent the message to a publish/subscribe service node configured to host a service for for establishing a subscription for the identified subscriber to receive a notification including a current value of a tuple identified based on an evaluation of the tuple identifier expression.
